(19) United States
(12) Patent Application Publication
(10) Pub. No.: US 2026/0080235 A1
(43) Pub. Date: Mar. 19, 2026

(54) NEURAL NETWORK DEVICE AND SIGNAL PROCESSING METHOD

(71) Applicant: KABUSHIKI KAISHA TOSHIBA, Tokyo (JP)

(72) Inventors: Kumiko Nomura, Shinagawa Tokyo (JP); Yoshifumi Nishi, Yokohama Kanagawa (JP); Junichi Sugino, Kawasaki Kanagawa (JP)

(73) Assignee: KABUSHIKI KAISHA TOSHIBA, Tokyo (JP)

(21) Appl. No.: 19/284,955

(22) Filed: Jul. 30, 2025

(30) Foreign Application Priority Data
Sep. 17, 2024 (JP) 2024-159988

(51) Int. Cl. G06N 3/065; G06N 3/049

(52) U.S. Cl. CPC G06N 3/065; G06N 3/049

(57) ABSTRACT

A neural network device according to an embodiment includes a plurality of synapse circuits and a plurality of neuron circuits. In a first neuron circuit out of the neuron circuits, a synaptic current is supplied to a first terminal from each of one or more first synapse circuits out of the synapse circuits. The first neuron circuit includes a charge accumulation circuit, a spike output circuit, and a cutoff circuit. The charge accumulation circuit accumulates charge corresponding to the synaptic current and generates a membrane potential corresponding to the accumulated charge. The spike output circuit outputs a spike signal when the membrane potential is higher than a preset threshold potential. During a cutoff period that is a predetermined period of time after the output of the spike signal, the cutoff circuit stops the supply of the synaptic current from the first terminal to the charge accumulation circuit.

### CROSS-REFERENCE TO RELATED APPLICATIONS

This application is based upon and claims the benefit of priority from Japanese Patent Application No. 2024-159988, filed on Sep. 17, 2024; the entire contents of which are incorporated herein by reference.

### FIELD

Embodiments described herein relate generally to a neural network device and a signal processing method.

### BACKGROUND

In recent years, with advances in computer hardware, typified by graphical processing units (GPU), artificial intelligence technology has been rapidly developing. For example, image recognition and classification techniques, typified by convolutional neural networks (CNN), have already been used in various scenes in the real world. Artificial intelligence technology that is widely used now is based on the mathematical model in which the behavior of a biological neural circuit network is simplified. Such artificial intelligence technology is therefore implemented using computers, such as GPUs.

However, the implementation of the artificial intelligence technology with GPUs requires a large amount of power. In particular, learning operation in which features are extracted from a large volume of data and stored comes with an enormous amount of computation. For this reason, such a learning operation requires a very large amount of power, and is considered to be difficult to execute in an edge device, for example.

On the other hand, although its energy consumption is as low as 20 W, the human brain constantly learns an enormous volume of data online. Therefore, a technique of performing information processing by relatively faithfully reproducing brain activity by electric circuits has been studied in various countries of the world.

In the brain's neural circuit network, information is transmitted from a neuron (nerve cell) to a neuron as a voltage spike. A coupler called a synapse couples a neuron to a neuron. A voltage spike generated by a certain neuron is input to a post-neuron as a subsequent stage via a synapse. At this time, the strength of the voltage spike input to the post-neuron is adjusted by a synaptic weight, which is the coupling strength of the synapse.

The synapse converts the voltage spike received from a pre-neuron at a preceding stage into a synaptic current corresponding to the synaptic weight and gives the synaptic current to the post-neuron. When the synaptic weight is large, the synapse gives a large synaptic current to the post-neuron; when the synaptic weight is small, the synapse gives a small synaptic current to the post-neuron.

Neurons hold inner potentials called membrane potentials. When having received a synaptic current from a synapse, the neuron increases the membrane potential in accordance with a magnitude of the received synaptic current. In addition, when no synaptic current is applied, the neuron reduces the membrane potential with the lapse of time. Accordingly, the neuron increases the membrane potential with continuous application of the synaptic current at short time intervals, and reduces the membrane potential with no application of the synaptic current for a long time. The neuron then generates a voltage spike when the membrane potential rises to reach a threshold potential being a firing threshold. The generation of a voltage spike by a neuron is called firing.

In addition, upon firing, a neuron returns its membrane potential to an initial potential. After returning the membrane potential to the initial potential, the neuron maintains the membrane potential at the initial potential for a given period of time called a refractory period of time. Thus, even when synaptic currents are applied during the refractory period of time, neurons do not increase the membrane potential. The neuron then changes the membrane potential after the end of the refractory period of time.

Such information processing mimicking the information transmission principle of the brain's neural circuit network is called spiking neural networks. The spiking neural network performs no numerical computation and performs information processing by increasing/reducing the membrane potential corresponding to the voltage spikes, generating the voltage spikes, and transmitting the voltage spikes by synapses. Conventional artificial intelligence requires an enormous amount of computation in learning operation. In contrast, the spiking neural network does not perform numerical computation, and thus is considered to efficiently perform data processing. For such reasons, in recent years, studies of implementing a spiking neural network on a semiconductor chip have been actively conducted.

When the spiking neural network is implemented on a semiconductor chip, the neuron is implemented by an analog circuit using members such as a resistor, a capacitor, and a comparator. This circuit accumulates charge corresponding to the received synaptic current in a capacitor, and uses a voltage generated by the charge accumulated in the capacitor as a membrane potential.

Meanwhile, in a case where an arithmetic operation neural network that performs arithmetic operations, represented by CNN and the like, is implemented by a conventional spiking neural network, there will be an output of a result different from a case where the arithmetic operation neural network is implemented by a digital operation circuit such as a Central Processing Unit (CPU).

### BRIEF DESCRIPTION OF THE DRAWINGS

FIG. 1 is a diagram illustrating an example of a configuration of a neural network device;

FIG. 2 is a connection relationship diagram of peripheral circuits of a first neuron circuit;

FIG. 3 is a diagram illustrating a configuration of a first neuron circuit according to a first embodiment;

FIG. 4 is a flowchart illustrating a procedure of processing of the first neuron circuit;

FIG. 5 is a waveform diagram of a spike signal, a reset signal, and a cutoff signal;

FIG. 6 is an explanatory diagram of a component of a synaptic current transferred from a parasitic capacitance to a charge accumulation circuit;

FIG. 7 is a diagram illustrating a configuration of a first neuron circuit according to a second embodiment; and

FIG. 8 is a diagram illustrating a configuration of a first neuron circuit according to a third embodiment.

### DETAILED DESCRIPTION

A neural network device according to one embodiment includes a plurality of synapse circuits and a plurality of neuron circuits. Each of the synapse circuits is assigned with a synaptic weight. Each of the neuron circuits is configured to output a spike signal being a voltage pulse. Each of the synapse circuits is configured to acquire the spike signal output from one of the neuron circuits, and, in response to acquiring the spike signal, output a synaptic current of a current amount corresponding to the spike signal and the synaptic weight assigned to a corresponding synapse circuit. A first neuron circuit out of the neuron circuits is configured to receive, via a first terminal of the first neuron circuit, the synaptic current from each of one or more first synapse circuits out of the synapse circuits. The first neuron circuit includes a charge accumulation circuit, a spike output circuit, and a cutoff circuit. The charge accumulation circuit is configured to accumulate charge corresponding to the synaptic current and generate a membrane potential corresponding to the accumulated charge. The spike output circuit is configured to output the spike signal when the membrane potential is higher than a preset threshold potential. The cutoff circuit is configured to stop the supply of the synaptic current from the first terminal to the charge accumulation circuit during a cutoff period being a predetermined period of time after the output of the spike signal.

Hereinafter, a neural network device 10 according to an embodiment will be described with reference to the drawings.

In a case where an arithmetic operation neural network that performs arithmetic operations, represented by CNN and the like, is implemented by a conventional spiking neural network, there will be an output of a result different from a case where the arithmetic operation neural network is implemented by a digital operation circuit such as a CPU. One of the causes of this is that, although the arithmetic operation neural network implemented by a digital operation circuit outputs numerical information with no upper limit from each neuron, the arithmetic operation neural network implemented by a conventional spiking neural network has information loss in neurons. For example, in each neuron in the conventional spiking neural network, the membrane potential is not increased even when a synaptic current is applied during a period of time in which the membrane potential is returned to the initial potential after firing of the voltage spike. This causes a failure in transmitting a component of the synaptic current applied during the period of time in which the membrane potential is returned to the initial potential after the firing of the voltage spike, to the next neuron, leading to the loss in information to be transmitted. Therefore, in a case where the arithmetic operation neural network is to be implemented by the spiking neural network with high accuracy, it is necessary to reduce such information loss. Hereinafter, embodiments for solving such problems will be described.

### First Embodiment

The neural network device 10 according to a first embodiment is a spike-type neural network configured by hardware components. For example, the neural network device 10 is mounted on a semiconductor device by a process such as a Complementary Metal Oxide Semiconductor (CMOS).

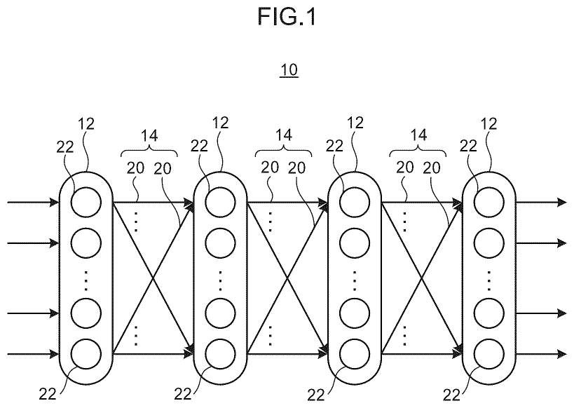

FIG. 1 is a diagram illustrating an example of a configuration of the neural network device 10. As an example, the neural network device 10 according to the first embodiment includes M (M is an integer of 2 or more) layers 12 and (M-1) synapse groups 14.

Each of the (M−1) synapse groups 14 includes a plurality of synapse circuits 20. A synaptic weight is assigned to each of the synapse circuits 20. The synaptic weights to be assigned to the synapse circuits 20 are set by learning processing. For example, the synaptic weights set for the synapse circuits 20 may be updated by a predetermined update rule such as Spike Timing Dependent Plasticity (STDP) or Spike Driven Synaptic Plasticity (SDSP).

Each of the M layers 12 includes a plurality of neuron circuits 22. The neuron circuits 22 each outputs a spike signal. The spike signal is a voltage pulse that changes from a second voltage to a first voltage and returns to the second voltage after a lapse of a given period of time from the change from the second voltage to the first voltage.

An m-th (m is an integer of 1 or more and (M−1) or less) synapse group 14 out of the (M−1) synapse groups 14 is disposed between an m-th layer 12 of the M layers 12 and an (m+1)-th layer 12 of the M layers 12.

Each of the synapse circuits 20 included in the m-th synapse group 14 acquires a spike signal output from any one neuron circuit 22 out of the neuron circuits 22 included in the m-th layer 12. When having acquired a spike signal, each of the synapse circuits 20 included in the m-th synapse group 14 outputs a synaptic current with a current amount corresponding to the synaptic weight that has been assigned and the spike signal that has been acquired. The synaptic weight may be represented by a binary value or may be represented by a multivalued discrete value of three or more values. Alternatively, the synaptic weight may be represented by an analog value, namely, by an amount of charge accumulated in a capacitor or the like or a resistance value of a variable resistor.

Each of the synapse circuits 20 included in the m-th synapse group 14 applies a synaptic current to one neuron circuit 22 out of the neuron circuits 22 included in the (m+1)-th layer 12.

Each of the neuron circuits 22 included in the (m+1)-th layer 12 out of the M layers 12 acquires a plurality of synaptic currents output from the m-th synapse group 14, and executes processing corresponding to a product-sum operation on the synaptic currents acquired. Note that the first layer 12 of the M layers 12 acquires a plurality of signals from an external device or an input layer. Subsequently, each of the neuron circuits 22 outputs a spike signal obtained by performing processing corresponding to an activation function on the signal representing the operation result.

In such a neural network device 10, the first layer 12 receives one or more signals from an external device or an input layer. Subsequently, the neural network device 10 outputs, from the m-th layer 12, one or more signals indicating a result of the operation executed by the neural network on the one or more signals received.

Such a neural network device 10 executes arithmetic neural network operation such as CNN. This makes it possible for the neural network device 10 to execute tasks such as image recognition and classification processing with less energy consumption and a small-scale circuit without using a CPU or a GPU, for example.

The neural network device 10 is not limited to the structure in which signals are transferred only in the forward direction as illustrated in FIG. 1. For example, the neural network device 10 may include a configuration in which any of the neuron circuits 22 acquires a synaptic current from the synapse circuit 20 that has acquired one or more spike signals output by the neuron circuit 22 or from the synapse circuit 20 that has acquired one or more spike signals output by another neuron circuit 22 at a subsequent stage of the neuron circuit 22. Moreover, the neural network device 10 may be a recurrent neural network. For example, in a case where the neural network device 10 is a recurrent neural network, for example, the neural network device 10 is applicable to a reservoir computing apparatus 24.

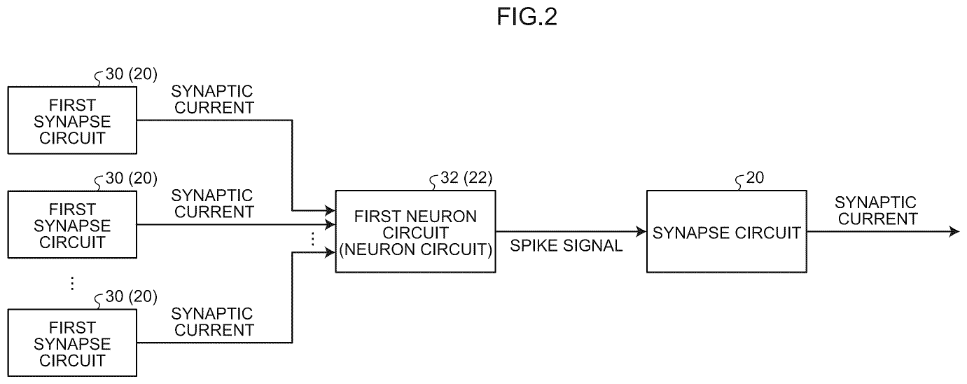

FIG. 2 is a diagram illustrating a connection relationship of peripheral circuits of a first neuron circuit 32.

Each of the neuron circuits 22 holds an inner potential called a membrane potential Vₘₑₘ. When having acquired a synaptic current from any of the synapse circuits 20 connected as a preceding stage, the neuron circuit 22 increases the membrane potential Vₘₑₘ in accordance with the magnitude of the synaptic current acquired. This makes it possible for each of the neuron circuits 22 to execute processing corresponding to the product-sum operation on the synaptic currents acquired.

When not having acquired the synaptic current, each of the neuron circuits 22 may reduce the membrane potential Vₘₑₘ with the lapse of time. In this case, each of the neuron circuits 22 increases the membrane potential Vₘₑₘ when having continuously acquired the synaptic current repeatedly at short time intervals, and reduces the membrane potential Vₘₑₘ when not having acquired the synaptic current for a long period of time. When the membrane potential Vₘₑₘ reaches a predetermined initial potential by reducing the membrane potential Vₘₑₘ with the lapse of time, each of the neuron circuits 22 stops reducing the membrane potential Vₘₑₘ.

Subsequently, when the membrane potential Vₘₑₘ has increased to be the predetermined threshold potential Vₜₕ or more, each of the neuron circuits 22 fires and outputs a spike signal to the synapse circuit 20 as a subsequent stage. When having fired, each of the neuron circuits 22 returns the membrane potential Vₘₑₘ to the initial potential.

During a cutoff period that is a predetermined period of time after firing, each of the neuron circuits 22 does not increase the membrane potential Vₘₑₘ and stops further firing even when a synaptic current is applied. In this case, after the end of the cutoff period, each of the neuron circuits 22 starts accumulation of charges corresponding to the synaptic current. The initial potential is lower than the threshold potential Vₜₕ.

Each of the synapse circuits 20 acquires the spike signal output from any one neuron circuit 22 of the neuron circuits 22.

Each of the synapse circuits 20 includes a circuit that generates current. When having acquired the spike signal, each of the synapse circuits 20 uses the circuit that generates current to output a synaptic current of a current amount corresponding to the synaptic weight that has been assigned and the spike signal that has been acquired, to the neuron circuit 22 in the subsequent stage.

The first neuron circuit 32 out of the neuron circuits 22 acquires a synaptic current from each of one or more first synapse circuits 30. The first neuron circuit 32 increases the membrane potential Vₘₑₘ in accordance with the synaptic current acquired from each of the one or more first synapse circuits 30.

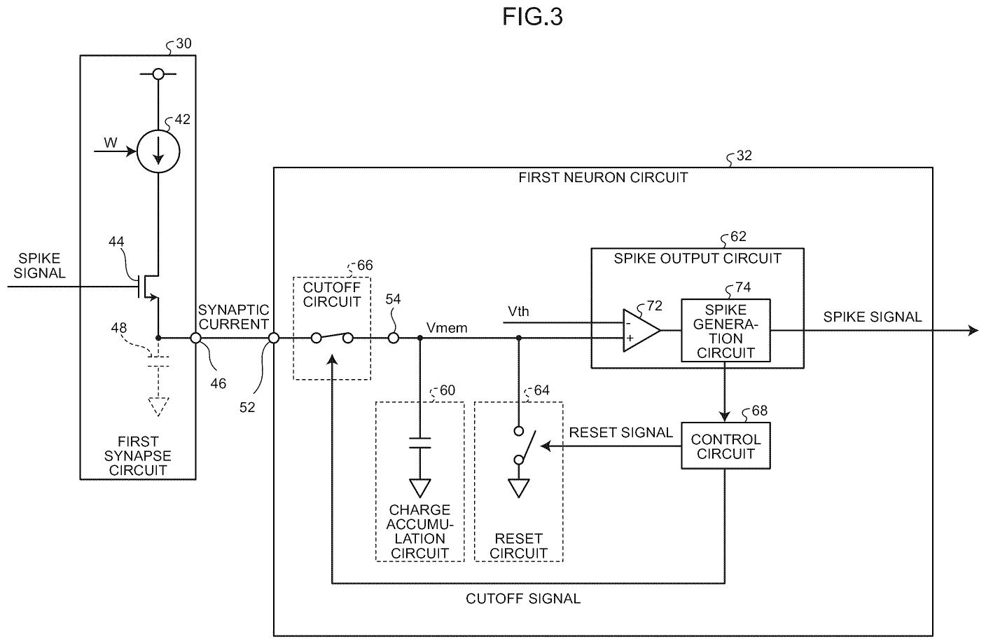

FIG. 3 is a diagram illustrating a configuration of the first neuron circuit 32 and the first synapse circuit 30 connected to a preceding stage of the first neuron circuit 32 according to the first embodiment.

In the neural network device 10, all the neuron circuits 22 may have the same configuration as the first neuron circuit 32, or some of the neuron circuits 22 may have the same configuration as the first neuron circuit 32.

The first neuron circuit 32 has a first terminal 52. In the first neuron circuit 32, a synaptic current is supplied to the first terminal 52 from each of one or more first synapse circuits 30 connected, as a preceding stage, to the first neuron circuit 32.

The first neuron circuit 32 is connected to one or more synapse circuits 20, as a subsequent stage. The first neuron circuit 32 outputs a spike signal to each of the one or more synapse circuits 20 connected as the subsequent stage.

The first synapse circuit 30 includes a synaptic current source 42 and a synapse output circuit 44.

The synaptic current source 42 is a variable current source. A synaptic weight (W) is assigned to the synaptic current source 42. The synaptic current source 42 outputs a synaptic current of a current amount corresponding to the synaptic weight (W) that has been assigned.

The synapse output circuit 44 receives the spike signal output from the neuron circuit 22 in the preceding stage. The synapse output circuit 44 switches whether to output the synaptic current output from the synaptic current source 42 to the first neuron circuit 32 in the subsequent stage via an output terminal 46 in accordance with the spike signal output from the neuron circuit 22 in the preceding stage. For example, the synapse output circuit 44 outputs the synaptic current to the first neuron circuit 32 when the spike signal indicates the first voltage, and does not output the synaptic current to the first neuron circuit 32 when the spike signal indicates the second voltage.

In the present example, the synapse output circuit 44 is a Metal-Oxide-Semiconductor Field Effect Transistor (MOSFET). In the example of FIG. 3, the synapse output circuit 44 is an N-channel MOSFET. The synapse output circuit 44, which is an N-channel MOSFET, has a gate to which a spike signal is applied, a drain connected to the synaptic current source 42, and a source connected to the output terminal 46. The synapse output circuit 44, which is a MOSFET, switches whether to apply a synaptic current between the drain and the source in accordance with the spike signal.

The first synapse circuit 30 having such a configuration can output a synaptic current of a current amount corresponding to the synaptic weight (W). The first synapse circuit 30 is not limited to such a configuration and may have another configuration.

Here, the first synapse circuit 30 has a parasitic capacitance 48 formed between the output terminal 46 and the ground terminal. The parasitic capacitance 48 accumulates charge corresponding to the synaptic current output from the synaptic current source 42 during a period of time in which the synapse output circuit 44 outputs the synaptic current from the output terminal 46, for example, during a period of time in which the spike signal acquired from the neuron circuit 22 in the preceding stage indicates the first voltage.

The first neuron circuit 32 includes a charge accumulation circuit 60, a spike output circuit 62, a reset circuit 64, a cutoff circuit 66, and a control circuit 68.

The charge accumulation circuit 60 accumulates charge corresponding to the synaptic current supplied to a second terminal 54. The charge accumulation circuit 60 generates a membrane potential Vₘₑₘ corresponding to the accumulated charge, at a second terminal 54. Accordingly, the charge accumulation circuit 60 increases the membrane potential Vₘₑₘ generated at the second terminal 54 every time the synaptic current is supplied to the second terminal 54. For example, the charge accumulation circuit 60 is a capacitor connected between the second terminal 54 and the ground terminal.

The threshold potential Vₜₕ is applied to the spike output circuit 62. The spike output circuit 62 outputs a spike signal when the membrane potential Vₘₑₘ generated from the charge accumulation circuit 60 is higher than the threshold potential Vₜₕ.

For example, the spike output circuit 62 includes a comparator 72 and a spike generation circuit 74 mounted on a semiconductor device.

In the comparator 72, a threshold potential Vₜₕ is applied to an inverting input terminal, while a non-inverting input terminal is connected to the second terminal 54. The comparator 72 outputs a determination signal indicating whether the membrane potential Vₘₑₘ is higher than the threshold potential Vₜₕ. For example, the comparator 72 outputs a determination signal indicating a first value (for example, logical L) when having determined that the membrane potential Vₘₑₘ is not higher than the threshold potential Vₜₕ, and indicating a second value (for example, logical H) when having determined that the membrane potential Vₘₑₘ is higher than the threshold potential Vₜₕ.

The spike generation circuit 74 acquires the determination signal from the comparator 72. The spike generation circuit 74 outputs a spike signal when the acquired determination signal changes from the first value indicating that the membrane potential Vₘₑₘ is not higher than the threshold potential Vₜₕ to the second value indicating that the membrane potential Vₘₑₘ is higher than the threshold potential Vₜₕ. More specifically, when the determination signal changes from the first value to the second value, the spike generation circuit 74 generates a spike signal that is a voltage pulse that changes from the second voltage to the first voltage and returns to the second voltage after a given period of time has elapsed. The spike generation circuit 74 gives the generated spike signal to the one or more synapse circuits 20 connected to the subsequent stage of the first neuron circuit 32.

The reset circuit 64 releases the charge accumulated in the charge accumulation circuit 60 in response to the spike signal being output from the spike output circuit 62. For example, the reset circuit 64 releases the charge accumulated in the charge accumulation circuit 60 during a period of time from when the spike signal changes from the second voltage to the first voltage to when the spike signal returns to the second voltage.

For example, the reset circuit 64 is a switch connected between the second terminal 54 and the ground terminal. For example, when the reset signal output from the control circuit 68 indicates logical L, the reset circuit 64 disconnects between the second terminal 54 and the ground terminal. When the reset signal output from the control circuit 68 indicates logical H, the reset circuit 64 short-circuits between the second terminal 54 and the ground terminal. The reset circuit 64 is implemented by a MOSFET that turns on or off by a reset signal, for example.

Such a reset circuit 64 can release the charges accumulated in the charge accumulation circuit 60 to the ground terminal and return the membrane potential Vₘₑₘ generated from the charge accumulation circuit 60 to the initial potential. Subsequently, after stopping the charge release from the charge accumulation circuit 60, the reset circuit 64 can accumulate the charge corresponding to the synaptic current supplied to the second terminal 54 in the charge accumulation circuit 60.

The cutoff circuit 66 supplies the synaptic current applied to the first terminal 52 to the charge accumulation circuit 60 during a period of time other than a cutoff period that is a predetermined period of time after the spike signal is output from the spike output circuit 62. In addition, during the cutoff period, the cutoff circuit 66 stops the supply of the synaptic current applied to the first terminal 52 to the charge accumulation circuit 60. The cutoff circuit 66 is a switch that is connected between the first terminal 52 and the second terminal 54. When the cutoff signal output from the control circuit 68 indicates logical H, the cutoff circuit 66 short-circuits between the first terminal 52 and the second terminal 54. When the cutoff signal output from the control circuit 68 indicates logical L, the cutoff circuit 66 disconnects between the first terminal 52 and the second terminal 54. The cutoff circuit 66 may be implemented by a MOSFET that turns on or off by a cutoff signal.

The control circuit 68 provides a reset signal to the reset circuit 64 to control the reset circuit 64. For example, the control circuit 68 sets the reset signal to logical H during a period of time in which the spike signal indicates the first voltage. In addition, the control circuit 68 sets the reset signal to logical L during a period of time in which the spike signal indicates the second voltage. With this configuration, the control circuit 68 can control the reset circuit 64 to release the charge accumulated in the charge accumulation circuit 60 during the period of time in which the spike signal indicates the first voltage, and can control the charge accumulation circuit 60 to accumulate the charge corresponding to the synaptic current during the period of time in which the spike signal indicates the second voltage.

Moreover, the control circuit 68 provides a cutoff signal to the cutoff circuit 66 to control the cutoff circuit 66. For example, the control circuit 68 sets the cutoff signal to logical L during a period of time from when the spike signal changes from the second voltage to the first voltage until the cutoff period elapses. In addition, the control circuit 68 sets the cutoff signal to the logical H during a period of time other than the cutoff period. With this configuration, the control circuit 68 can supply the synaptic current applied to the first terminal 52 to the charge accumulation circuit 60 during the period of time other than the cutoff period, and can stop the supply of the synaptic current applied to the first terminal 52 to the charge accumulation circuit 60 during the cutoff period.

The cutoff period may be the same as the period of time in which the spike signal indicates the first voltage or may be shorter than the period of time in which the spike signal indicates the first voltage. For example, the cutoff period may end at the same time as the spike signal changes from the first voltage to the second voltage or before the spike signal returns from the first voltage to the second voltage. The cutoff period may be a period of time that is synchronized with the reset signal. The cutoff period may be a period of time that matches a period of time called a refractory period of time during which the neuron does not react to a synaptic current applied thereto.

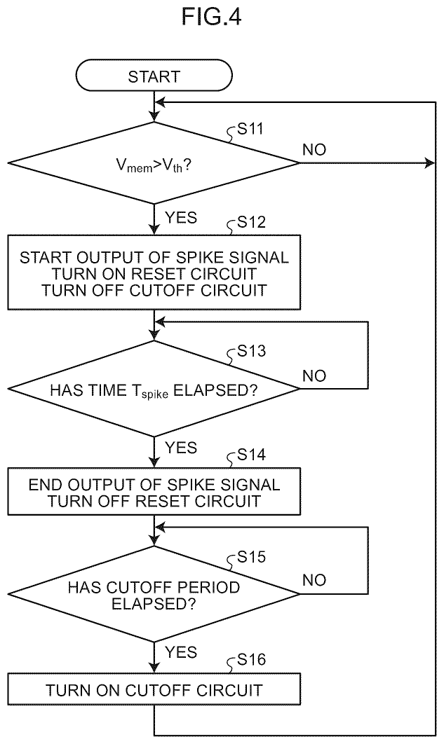

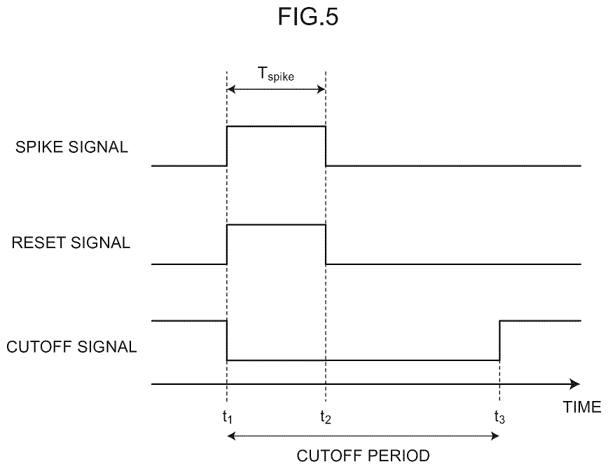

FIG. 4 is a flowchart illustrating a procedure of processing of the first neuron circuit 32. FIG. 5 is a diagram illustrating waveforms of a spike signal, a reset signal, and a cutoff signal.

The first neuron circuit 32 executes processing in the flow illustrated in FIG. 4.

First, in S11, the first neuron circuit 32 determines whether the membrane potential Vₘₑₘ generated from the charge accumulation circuit 60 is higher than the threshold potential Vₜₕ. When the membrane potential Vₘₑₘ is not higher than the threshold potential Vₜₕ (No in S11), the first neuron circuit 32 suspends the processing at S11. In response to determining that the membrane potential Vₘₑₘ is higher than the threshold potential Vₜₕ (Yes in S11), the first neuron circuit 32 proceeds to the processing of S12.

In S12, the first neuron circuit 32 starts outputting the spike signal. Thus, as illustrated at the timing of time t₁ in FIG. 5, the first neuron circuit 32 changes the spike signal from the second voltage to the first voltage.

Additionally, in S12, the first neuron circuit 32 turns on the reset circuit 64. Thus, as illustrated at the timing of time t₁ in FIG. 5, the first neuron circuit 32 changes the reset signal from logical L to logical H to start releasing of the charge accumulated in the charge accumulation circuit 60 to the ground terminal.

Moreover, in S12, the first neuron circuit 32 turns off the cutoff circuit 66. Thus, as illustrated at the timing of time t₁ in FIG. 5, the first neuron circuit 32 changes the cutoff signal from logical H to logical L to stop the supply of the synaptic current applied to the first terminal 52 to the charge accumulation circuit 60.

In S13, the first neuron circuit 32 determines whether time Tₛₚᵢₖₑ has elapsed since the start of outputting the spike signal. The time Tₛₚᵢₖₑ is a duration indicated by a pulse width of a spike signal being a voltage pulse. When the time Tₛₚᵢₖₑ has not elapsed (No in S13), the first neuron circuit 32 suspends the processing at S13. In response to determining that the time Tₛₚᵢₖₑ has elapsed (Yes in S13), the first neuron circuit 32 proceeds to the processing of S14.

In S14, the first neuron circuit 32 stops the output of the spike signal. Thus, as illustrated at the timing of time t₂ in FIG. 5, the first neuron circuit 32 changes the spike signal from the first voltage to the second voltage.

Additionally, in S14, the first neuron circuit 32 turns off the reset circuit 64. Thus, as illustrated at the timing of time t₂ in FIG. 5, the first neuron circuit 32 changes the reset signal from logical H to logical L to stop the releasing of the charge accumulated in the charge accumulation circuit 60 to the ground terminal.

Subsequently, in S15, the first neuron circuit 32 determines whether the cutoff period has elapsed since the start of outputting the spike signal. The cutoff period is a period of time during which the input of the synaptic current from the first synapse circuit 30 in the preceding stage is not to be received after the first neuron circuit 32 outputs the spike signal, and is longer than the time Tₛₚᵢₖₑ. When the cutoff period has not elapsed (No in S15), the first neuron circuit 32 suspends the processing at S15. In response to determining that the cutoff period has elapsed (Yes in S15), the first neuron circuit 32 proceeds to the processing of S16.

In S16, the first neuron circuit 32 turns on the cutoff circuit 66. Thus, as illustrated at the timing of time t₃ in FIG. 5, the first neuron circuit 32 changes the cutoff signal from logical L to logical H to enable the supply of the synaptic current applied to the first terminal 52 to the charge accumulation circuit 60.

After completing the processing of S16, the first neuron circuit 32 returns the processing to S11 and repeats the processing of S11 to S16.

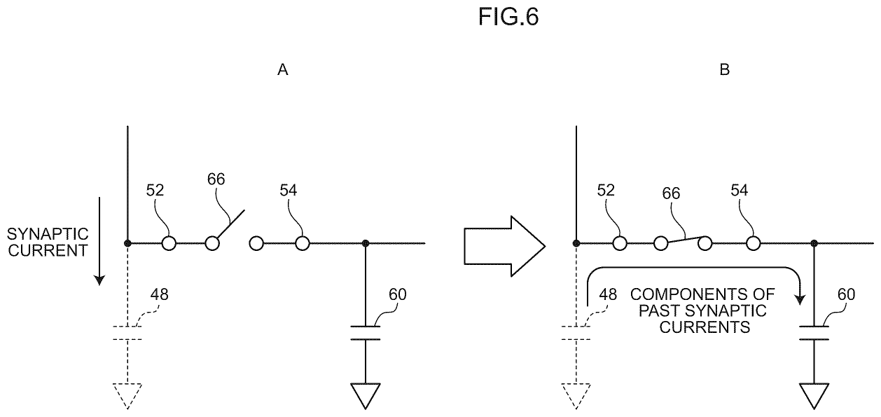

FIG. 6 is a diagram for illustrating a component of a synaptic current transferred from the parasitic capacitance 48 to the charge accumulation circuit 60.

As illustrated in A of FIG. 6, the cutoff circuit 66 disconnects between the first terminal 52 and the second terminal 54 during the period of time from the start of outputting the spike signal until the lapse of the cutoff period. Accordingly, in the cutoff period, the synaptic current generated from the first synapse circuit 30 in the preceding stage is accumulated in the parasitic capacitance 48 of the first synapse circuit 30, not being supplied to the charge accumulation circuit 60 of the first neuron circuit 32.

Subsequently, as illustrated in B of FIG. 6, after the end of the cutoff period, the cutoff circuit 66 short-circuits between the first terminal 52 and the second terminal 54. When the first terminal 52 and the second terminal 54 have been short-circuited, the charge accumulated in the parasitic capacitance 48 of the first synapse circuit 30 is transferred to the charge accumulation circuit 60 of the first neuron circuit 32. Accordingly, the components of the past synaptic current that have not been received by the first neuron circuit 32 due to the cutoff period are accumulated in the charge accumulation circuit 60 after the end of the cutoff period.

In this manner, in the first neuron circuit 32, the component of the synaptic current output from the first synapse circuit 30 in the preceding stage in the cutoff period is supplied after the end of the cutoff period. This makes it possible for the first neuron circuit 32 to transmit information based on the component of the synaptic current output from the first synapse circuit 30 in the preceding stage in the cutoff period to the neuron circuit 22 in the subsequent stage.

With this configuration of the neural network device 10 according to the present embodiment, it is possible to implement a spiking network with high accuracy with reduced information loss. Consequently, the neural network device 10 according to the present embodiment can accurately execute the operation of the neural network implemented by the digital operation circuit including the CPU, such as the arithmetic operation neural network, for example.

### Second Embodiment

Hereinafter, a neural network device 10 according to a second embodiment will be described. Since the neural network device 10 according to the second embodiment has substantially the same function and configuration as the neural network device 10 of the first embodiment, components having substantially the same function and configuration as those of the first embodiment are denoted by the same reference numerals, and detailed description thereof is omitted except for their differences. The similar applies to the description of a third embodiment.

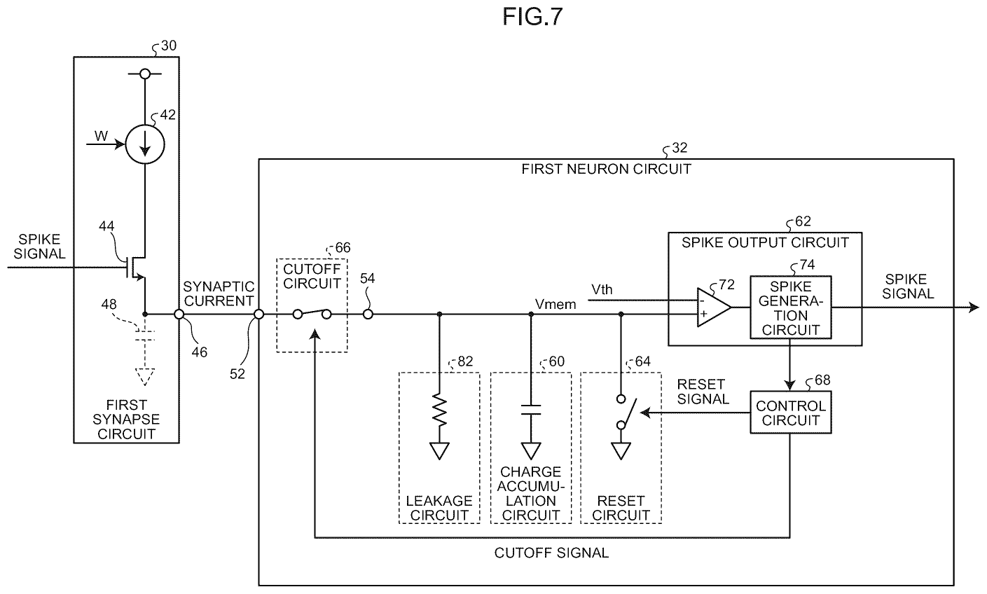

FIG. 7 is a diagram illustrating a configuration of a first neuron circuit 32 according to the second embodiment.

The first neuron circuit 32 according to the second embodiment further includes a leakage circuit 82.

The leakage circuit 82 reduces the charge accumulated in the charge accumulation circuit 60 with the lapse of time. The leakage circuit 82 is connected in parallel between two terminals of the charge accumulation circuit 60, and applies a leakage current from the second terminal 54 to the ground terminal to leak the charge accumulated in the charge accumulation circuit 60. Therefore, in a case where the synaptic current is not supplied, the leakage circuit 82 can reduce the membrane potential Vₘₑₘ generated at the second terminal 54, with the lapse of time.

For example, the leakage circuit 82 is a resistive element mounted on a semiconductor device. The resistive element is connected between the second terminal 54 and the ground terminal. The magnitude of the leakage current applied from the leakage circuit 82 is determined by the resistance value of the resistive element and the membrane potential Vₘₑₘ generated from the charge accumulation circuit 60. The resistive element has a relatively large resistance value of 100 MΩ or more, for example, and releases the charge accumulated in the charge accumulation circuit 60 over a sufficiently long time. Alternatively, the resistive element may be formed with a transistor. In this case, the magnitude of the leakage current is determined by the gate voltage of the transistor.

In this manner, in the neural network device 10 according to the second embodiment, the first neuron circuit 32 further includes the leakage circuit 82, making it possible to implement a spiking neural network using a Leaky Integrate-and-Fire (LIF) type neuron model.

### Third Embodiment

Hereinafter, a neural network device 10 according to a third embodiment will be described.

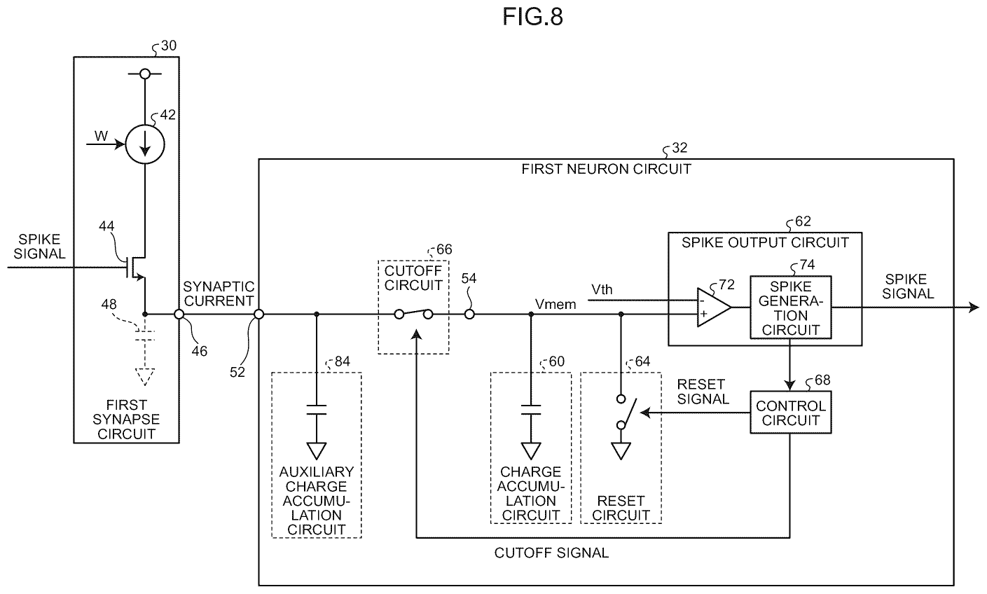

FIG. 8 is a diagram illustrating a configuration of a first neuron circuit 32 according to the third embodiment.

The first neuron circuit 32 according to the third embodiment further includes an auxiliary charge accumulation circuit 84.

The auxiliary charge accumulation circuit 84 is provided in a preceding stage of the cutoff circuit 66. The auxiliary charge accumulation circuit 84 accumulates charge corresponding to the synaptic current applied to the first terminal 52. For example, the auxiliary charge accumulation circuit 84 is a capacitor connected between the first terminal 52 and the ground terminal.

Together with the parasitic capacitance 48 of the first synapse circuit 30, the auxiliary charge accumulation circuit 84 can accumulate, in the cutoff period, charge corresponding to the synaptic current generated from the first synapse circuit 30 in the preceding stage. After the end of the cutoff period, the charge accumulated in the auxiliary charge accumulation circuit 84 is transferred to the charge accumulation circuit 60 of the first neuron circuit 32.

The first neuron circuit 32 according to the third embodiment can accumulate more charges in the cutoff period by including the auxiliary charge accumulation circuit 84. Accordingly, the first neuron circuit 32 according to the third embodiment can accumulate charges without loss even when a large synaptic current is output in the cutoff period. In this manner, the neural network device 10 according to the third embodiment can further reduce the loss of information to be transmitted, making it possible to implementing a spiking network with higher accuracy. The auxiliary charge accumulation circuit 84 may also be applied to the first neuron circuit 32 according to the second embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### Supplementary Notes

The above embodiments can be summarized in the following technical schemes.

### (Technical Scheme 1)

A neural network device comprising:
a plurality of synapse circuits, each of the synapse circuits being assigned with a synaptic weight; and
a plurality of neuron circuits, each of the neuron circuits being configured to output a spike signal being a voltage pulse, wherein
each of the synapse circuits is configured to
   acquire the spike signal output from one of the neuron circuits, and,
   in response to acquiring the spike signal, output a synaptic current of a current amount corresponding to the spike signal and the synaptic weight assigned to a corresponding synapse circuit,
a first neuron circuit out of the neuron circuits is configured to receive, via a first terminal of the first neuron circuit, the synaptic current from each of one or more first synapse circuits out of the synapse circuits, and
the first neuron circuit includes
   a charge accumulation circuit configured to accumulate charge corresponding to the synaptic current and generate a membrane potential corresponding to the accumulated charge,
   a spike output circuit configured to output the spike signal when the membrane potential is higher than a preset threshold potential, and
   a cutoff circuit configured to stop the supply of the synaptic current from the first terminal to the charge accumulation circuit during a cutoff period being a predetermined period of time after the output of the spike signal.

### (Technical Scheme 2)

The neural network device according to the technical scheme 1, wherein
the charge accumulation circuit is a capacitor connected between a second terminal of the first neuron circuit and a ground terminal,
the charge accumulation circuit is configured to generate the membrane potential from the second terminal,
the cutoff circuit is a switch connected between the first terminal and the second terminal, and
the cutoff circuit is configured to
   short-circuit between the first terminal and the second terminal during the cutoff period, and
   disconnect between the first terminal and the second terminal during a period of time other than the cutoff period.

### (Technical Scheme 3)

The neural network device according to the technical scheme 1 or 2, wherein the first neuron circuit further includes a reset circuit configured to release the charge accumulated in the charge accumulation circuit in response to the spike signal being output.

### (Technical Scheme 4)

The neural network device according to any one of the technical schemes 1 to 3, wherein the first neuron circuit further includes a leakage circuit configured to reduce the charge accumulated in the charge accumulation circuit with a lapse of time.

### (Technical Scheme 5)

The neural network device according to the technical scheme 4, wherein the leakage circuit is a resistive element connected between a second terminal of the first neuron circuit and a ground terminal.

### (Technical Scheme 6)

The neural network device according to any one of the technical schemes 1 to 5, further comprising an auxiliary charge accumulation circuit provided in a preceding stage of the cutoff circuit, the auxiliary charge accumulation circuit being configured to accumulate the charge corresponding to the synaptic current.

### (Technical Scheme 7)

The neural network device according to the technical scheme 6, wherein the auxiliary charge accumulation circuit is a capacitor connected between the first terminal and a ground terminal.

### (Technical Scheme 8)

A signal processing method implemented by a neural network device including a plurality of synapse circuits and a plurality of neuron circuits, each of the synapse circuits being assigned with a synaptic weight, each of the neuron circuits outputting a spike signal being a voltage pulse, the signal processing method comprising:
by each of the synapse circuits,
   acquiring the spike signal output from one of the neuron circuits, and,
   in response to acquiring the spike signal, outputting a synaptic current of a current amount corresponding to the spike signal and the synaptic weight assigned to a corresponding synapse circuit;
by a first neuron circuit out of the neuron circuits,
   receiving, via a first terminal of the first neuron circuit, the synaptic current from each of one or more first synapse circuits out of the synapse circuits; and
by the first neuron circuit,
   accumulating charge corresponding to the synaptic current and generating a membrane potential corresponding to the accumulated charge,
   outputting the spike signal when the membrane potential is higher than a preset threshold potential, and
   stopping the supply of the synaptic current from the first terminal to the charge accumulation circuit during a cutoff period being a predetermined period of time after the output of the spike signal.

What is claimed is:

1. A neural network device comprising:
a plurality of synapse circuits, each of the synapse circuits being assigned with a synaptic weight; and
a plurality of neuron circuits, each of the neuron circuits being configured to output a spike signal being a voltage pulse, wherein
each of the synapse circuits is configured to
acquire the spike signal output from one of the neuron circuits, and,
in response to acquiring the spike signal, output a synaptic current of a current amount corresponding to the spike signal and the synaptic weight assigned to a corresponding synapse circuit,
a first neuron circuit out of the neuron circuits is configured to receive, via a first terminal of the first neuron circuit, the synaptic current from each of one or more first synapse circuits out of the synapse circuits, and
the first neuron circuit includes
a charge accumulation circuit configured to accumulate charge corresponding to the synaptic current and generate a membrane potential corresponding to the accumulated charge,
a spike output circuit configured to output the spike signal when the membrane potential is higher than a preset threshold potential, and
a cutoff circuit configured to stop the supply of the synaptic current from the first terminal to the charge accumulation circuit during a cutoff period being a predetermined period of time after the output of the spike signal.

2. The neural network device according to claim 1, wherein
the charge accumulation circuit is a capacitor connected between a second terminal of the first neuron circuit and a ground terminal,
the charge accumulation circuit is configured to generate the membrane potential from the second terminal,
the cutoff circuit is a switch connected between the first terminal and the second terminal, and
the cutoff circuit is configured to
short-circuit between the first terminal and the second terminal during the cutoff period, and
disconnect between the first terminal and the second terminal during a period of time other than the cutoff period.

3. The neural network device according to claim 1, wherein the first neuron circuit further includes a reset circuit configured to release the charge accumulated in the charge accumulation circuit in response to the spike signal being output.

4. The neural network device according to claim 1, wherein the first neuron circuit further includes a leakage circuit configured to reduce the charge accumulated in the charge accumulation circuit with a lapse of time.

5. The neural network device according to claim 4, wherein the leakage circuit is a resistive element connected between a second terminal of the first neuron circuit and a ground terminal.

6. The neural network device according to claim 1, further comprising an auxiliary charge accumulation circuit provided in a preceding stage of the cutoff circuit, the auxiliary charge accumulation circuit being configured to accumulate the charge corresponding to the synaptic current.

7. The neural network device according to claim 6, wherein the auxiliary charge accumulation circuit is a capacitor connected between the first terminal and a ground terminal.

8. A signal processing method implemented by a neural network device including a plurality of synapse circuits and a plurality of neuron circuits, each of the synapse circuits being assigned with a synaptic weight, each of the neuron circuits outputting a spike signal being a voltage pulse, the signal processing method comprising:
by each of the synapse circuits,
acquiring the spike signal output from one of the neuron circuits, and,
in response to acquiring the spike signal, outputting a synaptic current of a current amount corresponding to the spike signal and the synaptic weight assigned to a corresponding synapse circuit;
by a first neuron circuit out of the neuron circuits,
receiving, via a first terminal of the first neuron circuit, the synaptic current from each of one or more first synapse circuits out of the synapse circuits; and
by the first neuron circuit,
accumulating charge corresponding to the synaptic current and generating a membrane potential corresponding to the accumulated charge,
outputting the spike signal when the membrane potential is higher than a preset threshold potential, and
stopping the supply of the synaptic current from the first terminal to the charge accumulation circuit during a cutoff period being a predetermined period of time after the output of the spike signal.
